(19) United States
(12) Patent Application Publication
(10) Pub. No.: US 2003/0206385 A1
(43) Pub. Date: Nov. 6, 2003

(54) Low speed resistor and stall protection assembly for engine cooling fan motor

(76) Inventors: Andrew Lakerdas, London (CA); John Bere, London (CA); Martin Volkening, London (CA)

Correspondence Address: Siemens Corporation, Intellectual Property Department, 186 Wood Avenue South, Iselin, NJ, 08830, US

(21) Appl. No.: 10/210,151

(22) Filed: Aug. 1, 2002

Related U.S. Application Data
(60) Provisional application No. 60/377,337, filed on May 1, 2002.

(51) Int. Cl. H02H 7/08

(52) U.S. Cl. 361/23

(57) ABSTRACT

A resistor and stall protection assembly for a permanent magnet brush-type DC motor includes a first speed circuit for operating the motor at a first speed. The first speed circuit includes at least one resistor 12 for reducing voltage to the motor 14. A second speed circuit is provided for operating the motor at a speed greater than the first speed. A first connecting structure 16 is constructed and arranged to connect the assembly to a source of power 18. A second connecting structure 20 is constructed and arranged to connect the assembly to the motor 14. A sensing structure 22 is constructed and arranged to sense a motor stall condition, and a circuit protecting device 24 such as a relay or transistor is constructed and arranged to interrupt power to the motor 14 when the motor is in the stall condition.

### RELATED APPLICATONS

This application claims benefit to U.S. provisional application 60/377,337, filed May 1, 2001, which is incorporated herein by reference.

### FIELD OF THE INVENTION

The invention relates to vehicle engine cooling fan motors and, more particularly, to a low speed resistor assembly with integrated stall protection for all motor speeds.

### BACKGROUND OF THE INVENTION

One of the greatest challenges of permanent magnet brush type DC motors is to achieve different speeds of operation in conjunction with stall protection. Typically, lower speeds of the motor are achieved by adding a resistor or resistors in series with the motor.

In the event the motor is stalled, for example if some foreign object is blocking the fan wheel or the motor, some form of blocked rotor protection is required to prevent damage of the motor or vehicle wiring harness. Without stall protection, it is possible for electrical damage or even fire to occur from overheating of the motor.

Normally a fuse or other fusible device is used with an engine cooling fan. Additionally, low speed resistor assemblies also use some sort of fuse or breaker for interrupting low speed in the event of a motor stall condition. Since the high-speed operation bypasses the resistor, a separate circuit protector (usually a fuse) is used for high-speed stall protection.

Accordingly, there is a need to provide stall protection for all speeds of a motor from a single source, thereby eliminating the need for additional circuit protectors such as fuses.

### SUMMARY OF THE INVENTION

An object of the invention is to fulfill the need referred to above. In accordance with the principles of the present invention, this objective is achieved by providing a resistor and stall protection assembly for a permanent magnet brush-type DC motor including a first speed circuit for operating the motor at a first speed. The first speed circuit includes at least one resistor for reducing voltage to the motor. A second speed circuit is provided for operating the motor at a speed greater than the first speed. A first connecting structure is constructed and arranged to connect the assembly to a source of power. A second connecting structure is constructed and arranged to connect the assembly to the motor. A sensing structure is constructed and arranged to sense a motor stall condition, and a circuit protecting device is constructed and arranged to interrupt power to the motor when the motor is in the stall condition.

In accordance with another aspect of the invention a method is provided for sensing stall of a permanent magnet brush-type DC motor. The method provides a first speed circuit for operating the motor at a first speed. A second speed circuit is provided for operating the motor at a speed greater than the first speed. A determination is made as to whether a stall condition of the motor has occurred. When a stall condition is determined to have occurred, the current to the motor is interrupted.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is block diagram of a resistor and stall protection assembly provided in accordance with a first embodiment of the invention.

FIG. 2 is block diagram of a resistor and stall protection assembly provided in accordance with a second embodiment of the invention.

### DETAILED DESCRIPTION OF THE EXEMPLARY EMBODIMENT

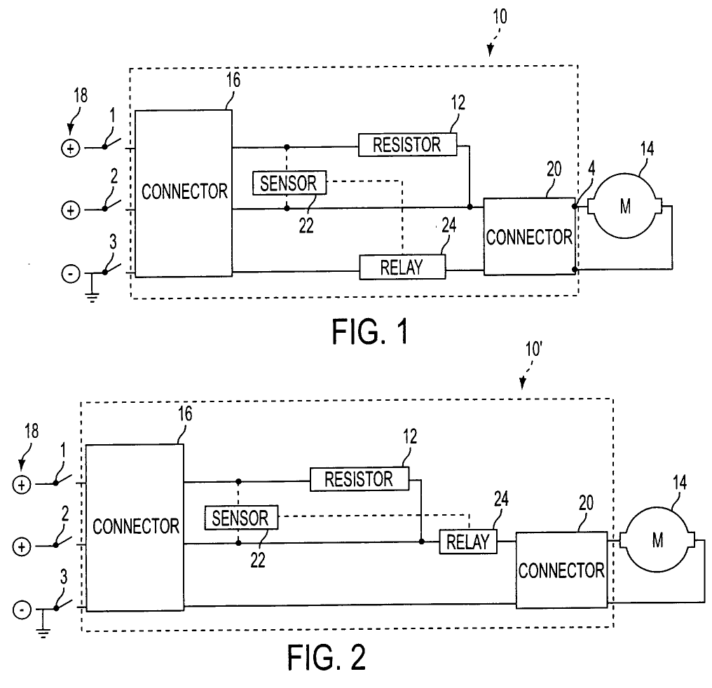

With reference to FIG. 1, an exemplary embodiment of a resistor and stall protection assembly for an engine-cooling fan motor is shown, generally indicated at 10, in accordance with the principles of the present invention. The assembly 10 includes at least one resistor for reducing voltage to a motor 14. A first connecting structure 16 is constructed and arranged to connect the assembly 10 to a source of power 18. A second connecting structure 20 is constructed and arranged to removable connect the assembly 10 to the motor 14. The motor 14 is preferably a permanent magnet brush type DC motor. In the embodiment, the first connecting structure 16 is preferably a connector or plug for removable connection to a vehicle wiring harness and the second connecting structure 20 is also preferably a connector or plug so that the assembly 10 is contained in a single package, the function of which will be explained below.

The assembly 10 also includes sensing structure 22 constructed and arranged to sense a motor stall condition. The sensing structure 22 is preferably a current sensor, temperature sensor, a device for sensing back EMF of the motor, or any other device for determining if the motor 14 is in a stall condition. A circuit protecting device 24 such as a relay or transistor is provided to interrupt power to the motor 14 when the sensing structure 22 determines that the motor is in a stall condition. In the embodiment of FIG. 1, a relay 24 is connected to the negative side of the motor 14. However, as shown in the assembly 10′ of FIG. 2, the relay 24 can be connected to the positive side of the motor 14.

The assembly 10 functions as follows. Power is applied from the vehicle low speed relay to terminal 1 (FIG. 1) and travels through a dropping resistor 12 hence reducing the voltage to the motor 14 at terminal 4. The motor 14 operates at low speed. Other lower speeds can be achieved by adding more resistors to the circuit.

High motor speed is achieved by applying power to terminal 2. Terminal 1 can stay energized or be shut off. In the embodiment, the sensing structure 22 detects current conditions for both the low-speed and high-speed circuit. If the motor 14 is stalled, there is a significant change in current draw and the sensing structure 22 detects this condition. The circuit protecting device 24, added to either the positive or negative circuit going to the motor 14, interrupts the current to the motor 14 when the stall condition occurs.

With the invention, stall protection is now applied to all speeds from a single source eliminating the need for additional circuit protectors such as fuses. Due to the plugs or connectors, the assembly 10 is easy to install onto a cooling fan module and has all stall protection as well as the speed control function contained in one package. The motor 14 is a standard motor and the vehicle wiring harness and electrical system would not require any changes when employing the assembly 10. Hence a conventional cooling fan module could have the stall protection function added directly by adding the assembly 10 between the power source and the motor 14 via the connecting structures 16 and 20. The assembly 10 enables a motor to be self-protecting and would make it very easy for a vehicle manufacture to retrofit this assembly 10. The assembly is also less expensive than providing discreet components for low speed motor operation and stall protection.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A resistor and stall protection assembly for a permanent magnet brush-type DC motor, the assembly comprising:
a first speed circuit for operating the motor at a first speed, the first speed circuit including at least one resistor for reducing voltage to the motor,
a second speed circuit for operating the motor at a speed greater than the first speed,
first connecting structure constructed and arranged to connect the assembly to a source of power,
second connecting structure constructed and arranged to connect the assembly to the motor,
sensing structure constructed and arranged to sense a motor stall condition, and
a circuit protecting device constructed and arranged to interrupt power to the motor when the motor is in the stall condition.

2. The assembly according to claim 1, wherein the circuit protecting device is one of a relay and transistor and is arranged to be electrically connected to a negative side of the motor.

3. The assembly according to claim 1, wherein the circuit protecting device is one of a relay and transistor and is arranged to be electrically connected to a positive side of the motor.

4. The assembly of claim 1, wherein the first connecting structure is constructed and arranged to be connectable to a low speed terminal to provide current through the at least one resistor and a high speed terminal to provide current to the motor, bypassing the at least one resistor.

5. The assembly of claim 1, wherein the sensing structure is a current sensor.

6. The assembly of claim 1, wherein the sensing structure is a temperature sensor.

7. The assembly of claim 1, wherein the sensing structure is constructed and arranged to sense back EMF.

8. A resistor and stall protection assembly for a permanent magnet brush-type DC motor, the assembly comprising:
means for reducing voltage to the motor thereby permitting the motor to operate at a speed less than a speed of the motor when voltage to the motor is not reduced,
first means for connecting the assembly to a source of power,
second means for connecting the assembly to the motor,
means for sensing a motor stall condition, and
means for interrupting power to the motor when the motor is in the stall condition.

9. The assembly according to claim 8, wherein the means for interrupting power is one of a relay and transistor arranged to be electrically connected to a negative side of the motor.

10. The assembly according to claim 8, wherein the means for interrupting power is one of a relay and transistor arranged to be electrically connected to a positive side of the motor.

11. The assembly of claim 8, wherein the means for reducing voltage is at least one resistor.

12. The assembly according to claim 11, wherein the first means for connecting is a connector constructed and arranged to be connectable to a low speed terminal to provide current through the at least one resistor and a high speed terminal to provide current to the motor, bypassing the at least one resistor.

13. The assembly according to claim 8, wherein the means for sensing is a current sensor.

14. The assembly according to claim 8, wherein the means for sensing is a temperature sensor.

15. The assembly according to claim 8, wherein the means for sensing is constructed and arranged to sense back EMF.

16. A method of sensing stall of a permanent magnet brush-type DC motor, the method including:
providing a first speed circuit for operating the motor at a first speed,
providing a second speed circuit for operating the motor at a speed greater than the first speed,
determining if a stall condition of the motor occurs, and
when a stall condition is determined to have occurred, interrupting current to the motor.

17. The method according to claim 16, wherein the current is interrupted by one of a relay and transistor.

18. The method according to claim 16, wherein the first speed circuit includes at least one resistor.

19. The method according to claim 16, wherein the determining step detects current draw for both the first and second speed circuits.
